(19) United States
(12) Patent Application Publication
(10) Pub. No.: US 2015/0107254 A1
(43) Pub. Date: Apr. 23, 2015

(54) Method and System for Improving the Efficiency of a Simple Cycle Gas Turbine System With a Closed Circuit Fuel Heating System

(71) Applicant: General Electric Company, Schenectady, NY (US)

(72) Inventors: Jason Brian Shaffer, Smyrna, GA (US); Alston Ilford Scipio, Mableton, GA (US); Sanji Ekanayake, Mableton, GA (US); Jean-Marc Carré, Marietta, GA (US); Paul Robert Fernandez, Woodstock, GA (US)

(73) Assignee: General Electric Company, Schenectady, NY (US)

(21) Appl. No.: 14/060,829

(22) Filed: Oct. 23, 2013

(51) Int. Cl. F02C 7/224

(52) U.S. Cl. CPC F02C 7/224
USPC 60/730; 60/736

(57) ABSTRACT

A closed circuit fuel heating system is provided for heating at least two types of fuel. The heating system includes a heat transfer subsystem disposed in a gas turbine system exhaust. A first heat exchange subsystem is coupled to a first fuel source and the heat transfer subsystem. The first heat exchange subsystem is provided with a control component for controlling a flow of a working fluid through the first heat exchange subsystem. A second heat exchange subsystem may be coupled to a second fuel source and the heat transfer subsystem. The second heat exchange subsystem is provided with a control component for controlling a flow of the working fluid through the second exchange subsystem. A subsystem for controlling the temperature of the working fluid is also provided.

### BACKGROUND OF THE INVENTION

The subject matter disclosed herein generally relates to gas turbine systems and more particularly to fuel heating systems for simple cycle gas turbine systems.

Simple cycle gas turbine systems are designed to use a variety of fuels ranging from gas to liquid, at a wide range of temperatures. In some instances, the fuel might be at a relatively low temperature when compared to the compressor discharge air temperature. Utilizing low temperature fuel impacts emissions, performance, and efficiency of the gas turbine system. To improve these characteristics, it is desirable to increase the fuel temperature before combusting the fuel.

By increasing the temperature of the fuel before it is burned, the overall thermal performance of the gas turbine system may be enhanced. Fuel heating generally improves gas turbine system efficiency by reducing the amount of fuel required to achieve the desired firing temperature. One approach to heating the fuel is to use electric heaters or heat derived from a combined cycle process to increase the fuel temperature. Another approach is to use the exhaust gas of the gas turbine system to preheat the fuel. One conventional way of capturing heat with the gas turbine system exhaust is to expose a working fluid line to the exhaust gas. The heated working fluid is then sent to a heat transfer subsystem to transfer heat from the working fluid to the fuel. However, existing systems do not provide the controls to more effectively prevent excess heat in the working fluid or the ability to heat multiple fuels using a single integrated system in a controllable manner.

### BRIEF DESCRIPTION OF THE INVENTION

The disclosure provides a method and associated system for heating fuel used in simple cycle gas turbine system using a closed circuit fuel heating system. The closed circuit fuel heating system is simple and avoids excess heat in the working fluid.

In accordance with one exemplary non-limiting embodiment, the invention relates to a system including a first fuel conduit providing a first fuel. A closed circuit working fluid subsystem containing a working fluid is provided. The closed circuit working fluid subsystem includes a heat transfer subsystem disposed in a gas turbine exhaust. The closed circuit working fluid subsystem also includes a first heat exchange subsystem that is coupled to the first fuel conduit and the heat transfer subsystem, the first heat exchange subsystem includes a control component for controlling the flow of the working fluid through the first heat exchange subsystem.

In another embodiment, a method for heating one of a plurality of fuels used in a simple cycle gas turbine system is provided. The method includes the steps of selecting a first fuel to be combusted in the simple cycle gas turbine system from the plurality of fuels; transferring heat from an exhaust to a working fluid flowing through a coil disposed in the exhaust; and conveying the working fluid to a heat exchange subsystem associated with the first fuel. The method further includes the steps of controlling a flow of the working fluid through the heat exchange subsystem and controlling the temperature of the working fluid. The method also includes the steps of flowing the first fuel through the heat exchange subsystem to heat the first fuel with the working fluid, and returning the working fluid to the coil.

In another embodiment, a system including a compressor; a combustor; and a turbine is provided. The system includes a working fluid heating subsystem that heats a working fluid. A first fuel heating subsystem coupled to the working fluid heating subsystem is also provided. The system further includes a temperature control subsystem that controls the temperature of the working fluid and a working fluid return subsystem that returns the working fluid to the working fluid heating subsystem. The system further includes a controller that controls the working fluid heating subsystem, the first fuel heating subsystem, and the temperature control subsystem.

### BRIEF DESCRIPTION OF THE DRAWINGS

Other features and advantages of the present invention will be apparent from the following more detailed description of the preferred embodiment, taken in conjunction with the accompanying drawings which illustrate, by way of example, the principles of certain aspects of the invention.

FIG. 1 is a high level schematic illustration of an embodiment of a closed circuit fuel heating system.

FIG. 2 is a detailed schematic illustration of an embodiment of a closed circuit fuel heating system.

FIG. 3 is a detailed schematic illustration of an embodiment of a working fluid heating subsystem.

FIG. 4 is a detailed schematic illustration of an embodiment of a heavy fuel oil heating subsystem.

FIG. 5 is a cross-sectional diagram of an embodiment of a heat trace.

FIG. 6 is a detailed schematic illustration of an embodiment of a liquid fuel heat exchange subsystem.

FIG. 7 is a detailed schematic illustration of an embodiment of a gas heat exchange subsystem.

FIG. 8 is a detailed schematic illustration of an embodiment of an over temperature protection subsystem.

FIG. 9 is a block diagram of a general purpose computer system.

### DETAILED DESCRIPTION OF THE INVENTION

Embodiments of the present invention have the technical effect of improving the efficiency of a simple cycle gas turbine system through the use of a closed circuit fuel heating system. A low complexity system provides improved heat rate during simple cycle gas turbine operation. A closed circuit working fluid subsystem is provided. The closed circuit working fluid subsystem includes a heat transfer subsystem to heat a working fluid. The heat transfer subsystem is provided with coils installed in the exhaust of the gas turbine system to retain energy that would be discarded otherwise. A heat exchange subsystem is disposed in the closed circuit working fluid subsystem and is coupled to the heat transfer subsystem. The heat exchange subsystem is coupled to a fuel source and is provided with a control component for controlling the flow of the working fluid and fuel through the heat exchange subsystem.

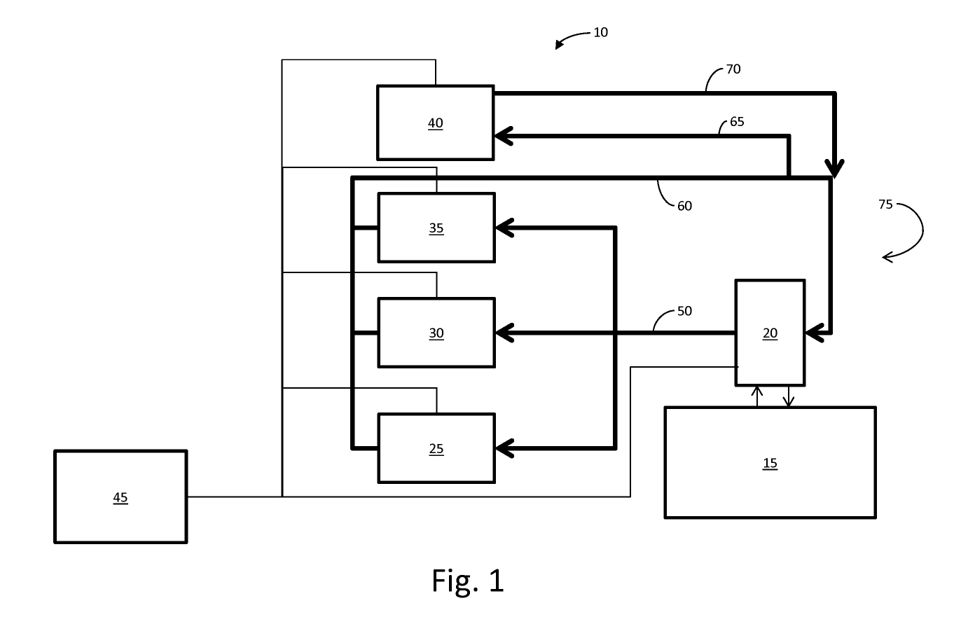

Illustrated in FIG. 1 is a closed circuit fuel heating system 10 for use with a simple cycle gas turbine system 15. The closed circuit fuel heating system 10 may include a subsystem for heating a working fluid (WF heating subsystem 20), a subsystem for heating heavy fuel oil (HFO heating subsystem 25), a liquid fuel heat exchange subsystem (LF heat exchange subsystem 30), a gas fuel heat exchange subsystem (GF-heat exchange subsystem 35) and an over temperature protection subsystem 40. The WF heating subsystem 20, the HFO heating subsystem 25, the LF heat exchange subsystem 30, the GF-heat exchange subsystem 35 and the over temperature protection subsystem 40 may be controlled by a controller 45. The HFO heating subsystem 25, the LF heat exchange subsystem 30, and the GF-heat exchange subsystem 35 are coupled to the WF heating subsystem 20 through input working fluid conduit 50. Working fluid from the HFO heating subsystem 25, the LF heat exchange subsystem 30, and the GF-heat exchange subsystem 35 is returned to the WF heating subsystem 20 through a working fluid return conduit 60. The over temperature protection subsystem 40 may be provided with working fluid through over temperature input conduit 65. Working fluid from the over temperature protection subsystem 40 is returned to the WF heating subsystem 20 through over temperature return conduit 70. Input working fluid conduit 50, working fluid return conduit 60, over temperature input conduit 65, and over temperature return conduit 70 define a closed circuit 75 for the working fluid.

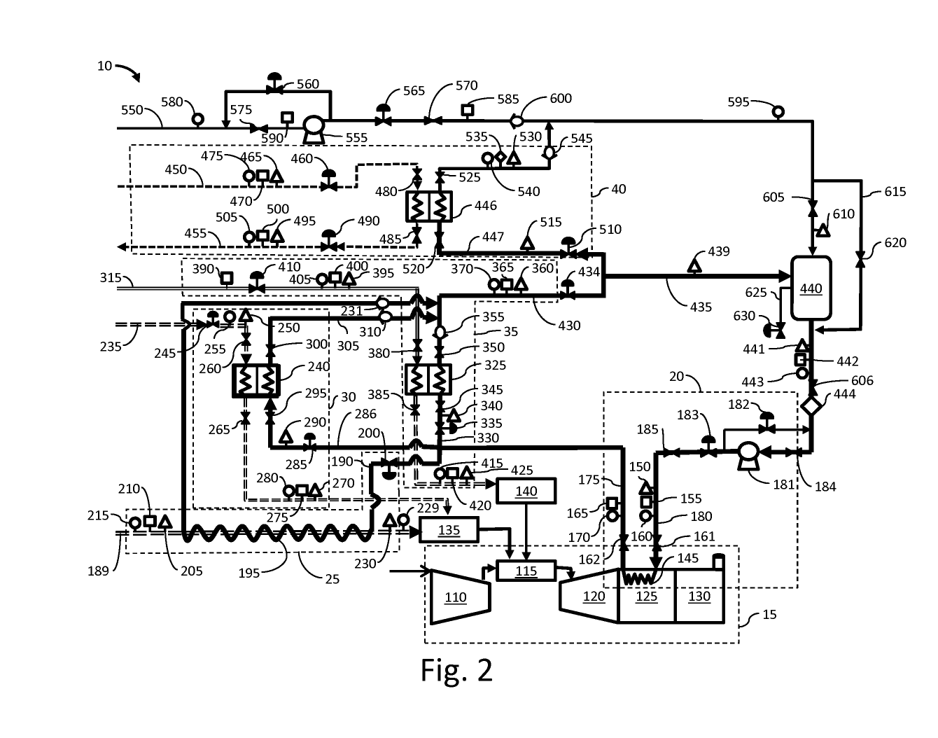

As shown in FIG. 2 the simple cycle gas turbine system 15 includes a compressor 110, a combustor 115, a turbine 120, an exhaust 125 and a stack 130. Associated with the simple cycle gas turbine system 15 is a liquid fuel/heavy fuel oil skid 135 that controls the liquid fuel and heavy fuel oil that is conveyed to the combustor 115. The liquid fuel/heavy fuel oil skid 135 provides the combustor with liquid fuel or heavy fuel oil at the appropriate pressure and temperature. Also associated with the simple cycle gas turbine system 15 is a DLN system 140 that controls the gas fuel conveyed to primary and secondary nozzles (not shown) in the combustor 115.

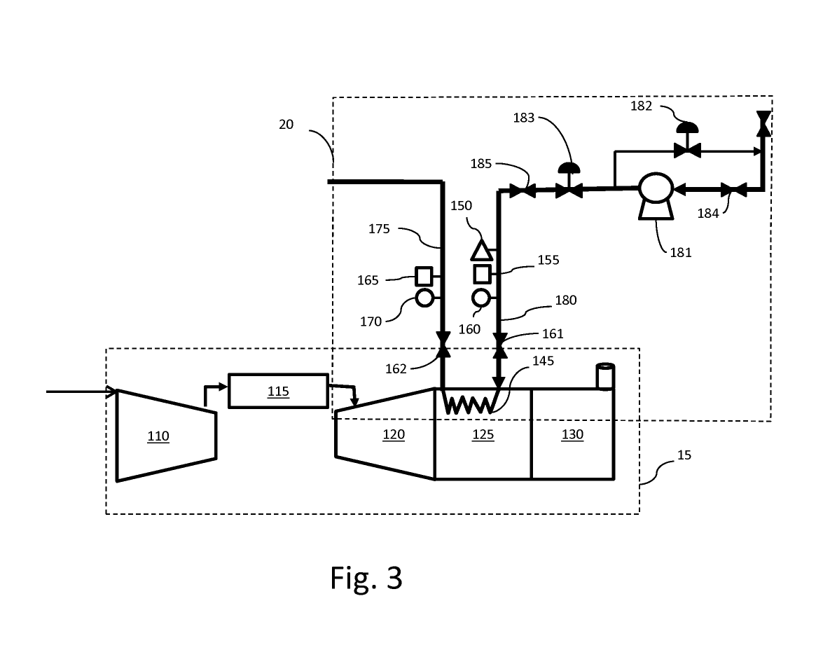

FIG. 2 and FIG. 3 illustrate the WF heating subsystem 20 in more detail. The WF heating subsystem 20 includes heat coils 145 disposed in the exhaust 125 of the simple cycle gas turbine system 15. The heat coils 145 may be made from metal tubing that is shaped to increase the rate of heat transfer from the exhaust 125 to a working fluid flowing through the heat coils 145. Examples of such shapes include U-shaped and serpentine shaped coils. The heat coils 145 may include fins to increase the rate of heat transfer. The WF heating subsystem 20 may also include a heat coil upstream flow meter (HCUFM 150), a heat coil upstream pressure transducer (HCUPT 155), and a heat coil upstream thermocouple (HCUT 160) disposed upstream from the heat coils 145. These instruments will measure the temperature, pressure, and flow rate of the working fluid upstream from the heat coils 145 and provide that information to the controller 45. The WF heating subsystem 20 may also be provided with upstream heat coil block valve 161 (disposed upstream from the heat coils 145) and downstream heat coil block valve 162 (disposed downstream from the heat coils 145). Upstream heat coil block valve 161 and downstream heat coil block valve 162 serve to isolate the heat coils 145 to enable the repair or replacement of the heat coils 145 when necessary. The WF heating subsystem 20 may also include a heat coil downstream pressure transducer (HCDPT 165) and a heat coil downstream thermocouple (HCDT 170) that measure the temperature and pressure of the working fluid downstream from the heat coils 145. The downstream pressure and temperature measurements are provided to the controller 45. The WF heating subsystem 20 also includes a first working fluid conduit 175 that contains the heated working fluid and a supply conduit 180 that contains working fluid that is returned to the heat coils 145. Working fluid pump 181 may be used to pump the working fluid to the heat coils 145. The working fluid pump 181 may be provided with a relief valve 182 for recirculating the working fluid exiting the working fluid pump 181 and diverting a portion of the flow of working fluid when necessary. Flow of the working fluid into the heat coils 145 may be controlled with a pump downstream control valve (PDCV 183). The working fluid pump 181 may be provided with an upstream pump block valve 184 (disposed upstream from the working fluid pump 181) and a downstream pump block valve 185 (disposed downstream from the working fluid pump 181). Upstream pump block valve 184 and downstream pump block valve 185 allow for the isolation of possible leaks of working fluid from the working fluid pump 181 and may also be beneficial for maintenance of the working fluid pump 181, including the ability to disconnect quickly the working fluid pump 181 from the closed circuit 75 without major disassembly of system components and conduits.

In operation heat is transferred from the exhaust 125 to a working fluid flowing through the heat coils 145 disposed in the exhaust 125. The working fluid is pumped by working fluid pump 181. The flow of working fluid through the heat coils 145 is controlled by PDCV 183 that is a control component for the WF heating subsystem 20. Information related to the flow rate, pressure, and temperature of the working fluid upstream and downstream from the heat coils 145 may be provided to the controller 45. Control of the flow rate of working fluid through the heat coils 145 by the PDCV 183 results in the control of the rate of heat transfer from the exhaust to the working fluid. Control over the rate of heat transfer to the working fluid provides control over the temperature and pressure of the working fluid.

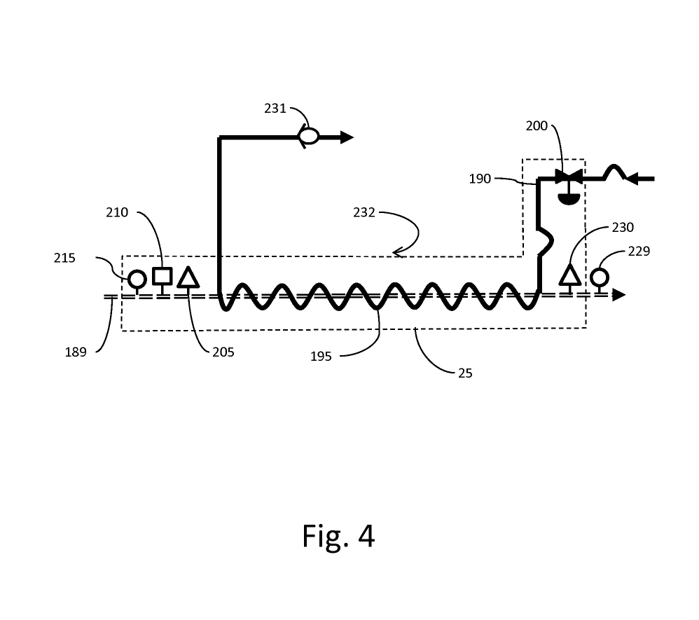

Shown in FIG. 2, and in more detail in FIG. 4, is the HFO heating subsystem 25 that may heat heavy fuel oil before it is conveyed to the combustor 115. HFO heating subsystem 25 includes a heavy fuel oil conduit 189 that conveys heavy fuel oil to the liquid fuel/heavy fuel oil skid 135 and further to the combustor 115. The HFO heating subsystem 25 also includes an HFO working fluid conduit 190 that conveys heated working fluid from the heat coils 145. The HFO heating subsystem 25 includes an HFO heat trace 195 which surrounds the heavy fuel oil conduit 189 and serves to transfer heat to the heavy fuel oil flowing through the heavy fuel oil conduit 189.

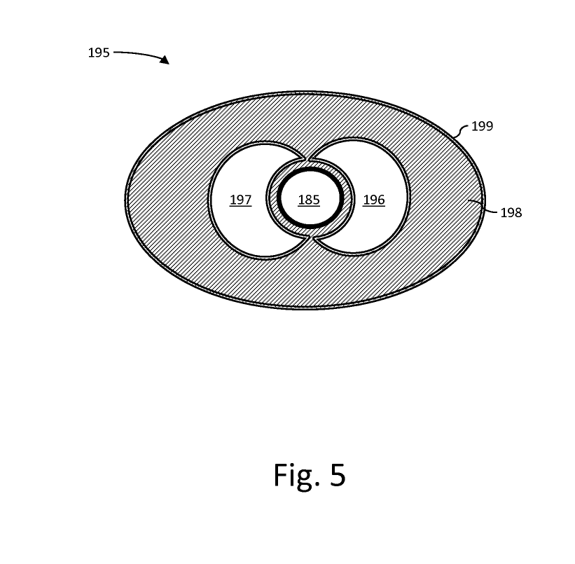

The HFO heat trace 195 may include a pair of conduits with lune (half-moon) shaped cross-sections (lune shaped conduits 196 and 197), shown in FIG. 5 The lune shaped conduits 196 and 197 may be surrounded with insulation 198 and contained within a housing 199.

The HFO heating subsystem 25 may include a control component such as a control valve (HFO WF control valve 200) that controls the flow rate of the working fluid flowing through the HFO heat trace 195 and thereby controls the amount of heat transferred to the heavy fuel oil. The HFO heating subsystem 25 may also include instrumentation including HFO upstream flow meter 205, HFO upstream pressure transducer 210, and HFO upstream thermocouple 215. That instrumentation may be used to measure the flow rate, pressure and temperature of the heavy fuel oil entering the HFO heat trace 195. An HFO downstream thermocouple 229 may be provided downstream of the HFO heat trace 195 in order to measure the temperature of the heavy fuel oil downstream of the HFO heat trace 195. HFO downstream thermocouple 229 monitors the temperature of the heavy fuel oil and provides temperature measurements to the controller 45. Furthermore, the controller 45 may also send commands to regulate the HFO WF control valve 200 by allowing for more or less flow of the WF through the HFO heat trace 195 as necessary based on downstream measurements of temperature and flow rate of the heavy fuel oil. A flow meter (HFO downstream flow meter 230) may be provided downstream of the HFO heat trace 195 to measure the flow rate of the heavy fuel oil and provide the measured flow rate information to the controller 45. A one way valve (HFO WF one-way valve 231) may be provided downstream of the HFO heating subsystem 25 to ensure a one way flow of the working fluid. HFO working fluid conduit 190 defines an HFO working fluid circuit 232.

In operation, heated working fluid flows through HFO working fluid conduit 190 and through HFO heat trace 195. There, the working fluid heats the heavy fuel oil flowing through heavy fuel oil conduit 189. HFO heat trace 195 serves as the heat transfer subsystem. The flow rate of the heavy fuel oil is measured using HFO upstream flow meter 205 and HFO downstream flow meter 230. The flow rate of the heated working fluid is controlled based on the flow rate of the heavy fuel oil by means of HFO WF control valve 200. Control of the flow rate of heated working fluid through the HFO heat trace 195 controls the rate of heat transfer from the heated working fluid to the heavy fuel oil. Additionally, control of the flow rate enables temperature management and pressure regulation. The working fluid is then ultimately returned to the WF heating subsystem 20 where it is reheated in the heat coils 145.

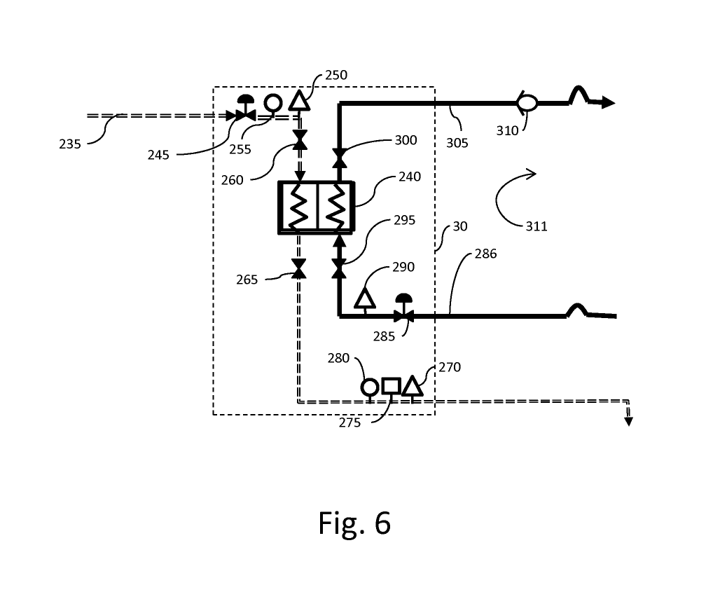

FIG. 2 and FIG. 6 illustrate LF heat exchange subsystem 30 in more detail. LF heat exchange subsystem 30 may include a liquid fuel conduit 235 that provides liquid fuel from a liquid fuel source (not shown) to the liquid fuel/heavy fuel oil skid 135 and further to the combustor 115. Liquid fuel flows through the liquid fuel conduit 235 to a reverse flow configured liquid fuel heat exchanger (LF heat exchanger 240). There the fuel is heated by heat transfer from the working fluid. A control component such as LF-HX upstream control valve 245 may be disposed on the liquid fuel conduit 235 to control the amount of liquid fuel flowing through the liquid fuel conduit 235. LF heat exchange subsystem 30 may also include a flow meter (LF-HX upstream flow meter 250) and a thermocouple (LF-HX upstream thermocouple 255) to measure the flow rate and temperature of the liquid fuel flowing into the LF heat exchanger 240. Block valves (LF-HX upstream block valve 260 and LF-HX downstream block valve 265) may be disposed upstream and downstream of the LF heat exchanger 240. LF-HX upstream block valve 260 and LF-HX downstream block valve 265 allow for the isolation of possible leaks of liquid fuel from the LF heat exchanger 240 and may also be beneficial for maintenance of LF heat exchange subsystem 30 (as well as the GF-heat exchange subsystem 35) including the ability to disconnect quickly the LF heat exchanger 240 from the closed circuit 75 without major disassembly of system components and conduits. The LF heat exchange subsystem 30 may also include instrumentation downstream from the LF heat exchanger 240, such as LF-HX downstream flow meter 270, LF-HX downstream pressure transducer 275, and LF-HX downstream thermocouple 280. The instrumentation measures the flow rate, pressure and temperature of the heated liquid fuel and provides the information to the controller 45. Control of the working fluid is provided by a control valve (LF-WF control valve 285) disposed on LF heat conduit 286. An LF-WF flow meter 290 is disposed upstream from the LF heat exchanger 240. LF-WF flow meter 290 measures the flow rate of the heated working fluid entering the LF heat exchanger 240. LF heat exchange subsystem 30 may also include LF-WF upstream block valve 295 (disposed upstream from the LF heat exchanger 240) and LF-WF downstream block valve 300 (disposed downstream from the LF heat exchanger 240). LF-WF upstream block valve 295 and LF-WF downstream block valve 300 are provided to enable the isolation of possible leaks of working fluid from the LF heat exchanger 240 and may also be beneficial for maintenance of LF heat exchange subsystem 30 (as well as the GF-heat exchange subsystem 35) including the ability to disconnect quickly the LF heat exchanger 240 from the closed circuit 75 without major disassembly of system components and conduits. Working fluid exiting the LF heat exchanger 240 is conveyed through LF-WF exit conduit 305 that may be provided with a LF-WF one way valve 310. LF heat conduit 286 and LF-WF exit conduit 305 define an LF working fluid circuit 311.

In operation, heated working fluid is conveyed through LF heat conduit 286 into LF heat exchanger 240. Liquid fuel flows through liquid fuel conduit 235 into LF heat exchanger 240 where the liquid fuel is heated by heat transferred from the working fluid. The flow rate of heated working fluid is controlled by LF-WF control valve 285, and the flow rate of liquid fuel is controlled by LF-HX upstream control valve 245. Control of the flow rate of the working fluid and the flow rate of the liquid fuel provides control of the rate of heat transfer from the working fluid to the liquid fuel. The flow rate of the liquid fuel entering and exiting the LF heat exchanger 240 is measured by LF-HX upstream flow meter 250 and LF-HX downstream flow meter 270. The pressure of the liquid fuel downstream from the LF heat exchanger 240 is measured using LF-HX downstream pressure transducer 275. The flow rate of the working fluid is controlled based on the flow rate, pressure and temperature of the liquid fuel.

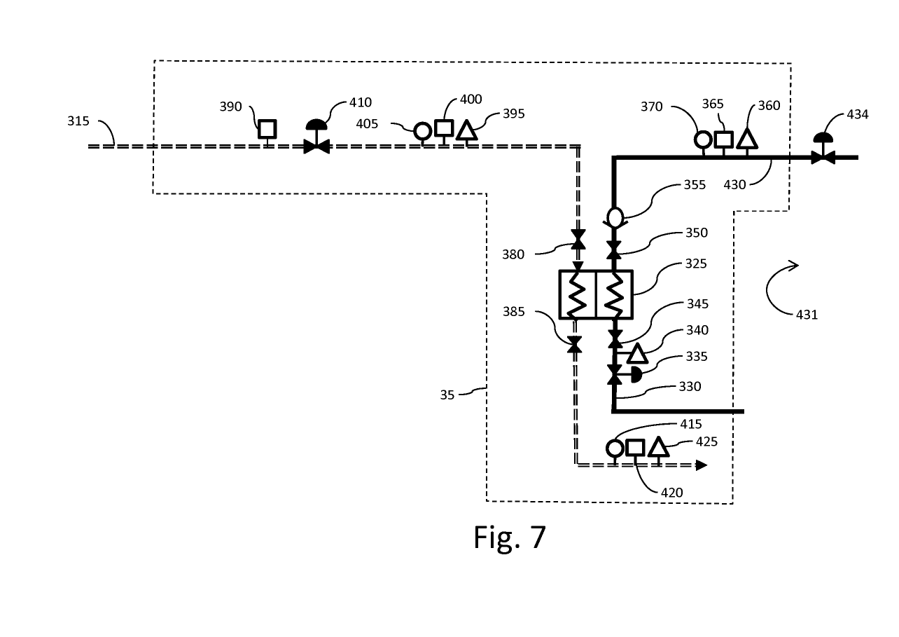

Illustrated in FIG. 2 and in more detail in FIG. 7 is the GF-heat exchange subsystem 35. The GF-heat exchange subsystem 35 includes a gas fuel conduit 315 that conveys gas fuel to a reverse flow configured heat exchanger (GF-heat exchanger 325). GF-heat exchanger 325 is supplied with heated working fluid through GF-WF conduit 330. The flow of the heated working fluid is controlled by a control component such as GF-WF control valve 335. The flow rate of the heated working fluid flowing into the GF-heat exchanger 325 may be measured by a GF-WF flow meter 340. The GF-heat exchanger 325 may be provided with GF-WF upstream block valve 345 and GF-WF downstream block valve 350 to isolate possible leaks of working fluid and may also be beneficial for maintenance of GF-heat exchange subsystem 35 (as well as LF heat exchange subsystem 30) including the ability to disconnect quickly the GF-heat exchanger 325 from the closed circuit 75 without major disassembly of system components and conduits. A GF-WF one way check valve 355 may be disposed downstream from the GF-heat exchanger 325 to ensure that the working fluid flows in only one direction. The GF-heat exchange subsystem 35 may also be provided with instrumentation downstream from the GF-heat exchanger 325 such as, for example, GF-WF downstream flow meter 360, GF-WF downstream pressure transducer 365, and GF-WF downstream thermocouple 370 disposed on WF-HX exit conduit 430. The instrumentation measures downstream flow rate, temperature and pressure of the working fluid and provides the information to the controller 45. GF-HX upstream block valve 380 and GF-HX downstream block valve 385 may be provided to isolate possible leaks of gas fuel in the GF-heat exchanger 325 and may also be beneficial for maintenance of GF-heat exchange subsystem 35 (as well as LF heat exchange subsystem 30) including the ability to disconnect quickly the GF-heat exchanger 325 from the closed circuit 75 without major disassembly of system components and conduits. A fuel analyzer 390 may be provided to determine the composition and properties of the gas fuel. Flow rate, pressure and temperature information of the gas fuel entering the GF-heat exchanger 325 may be provided by GF-HX upstream flow meter 395, GF-HX upstream pressure transducer 400, and GF-HX upstream thermocouple 405. The amount of gas flowing into the GF-heat exchanger 325 is controlled with GF-HX upstream control valve 410. Flow rate, pressure and temperature information of the heated gas fuel exiting the GF-heat exchanger 325 may be obtained with GF-HX downstream thermocouple 415, GF-HX downstream pressure transducer 420, and GF-HX downstream flow meter 425 disposed on gas fuel conduit 315. WF-HX exit conduit 430 and GF-WF conduit 330 define a GF working fluid circuit 431.

In operation, gas fuel flows through gas fuel conduit 315 and through the fuel analyzer 390 that provides gas composition measurements to the controller 45. The flow rate of the gas fuel is controlled by GF-HX upstream control valve 410. The gas fuel flows into the GF-heat exchanger 325. Heated working fluid flows through GF-WF conduit 330 and into the GF-heat exchanger 325. The flow rate of the working fluid flowing into the GF-heat exchanger 325 is controlled by means of GF-WF control valve 335. This, in turn, controls the rate of heat transfer to the gas fuel. The flow rate of the working fluid is monitored by means of GF-WF flow meter 340.

As shown in FIG. 2, the closed circuit fuel heating system 10 may also be provided with a WF downstream control valve 434 disposed downstream from the HFO heating subsystem 25, the LF heat exchange subsystem 30 and the GF-heat exchange subsystem 35. The WF downstream control valve 434 provides flow control of working fluid through each of HFO working fluid circuit 232, LF working fluid circuit 311 and GF working fluid circuit 431 (depending on which fuel is in use). Closing down of the WF downstream control valve 434 provides longer dwell times of the working fluid through the appropriate heat transfer subsystems (GF-heat exchanger 325, HFO heat trace 195 or LF heat exchanger 240) and thus provides increased heat transfer from the working fluid to the fuel. Opening of the WF downstream control valve 434 provides shorter dwell times of the working fluid through the heat transfer subsystems and thus decreases heat transfer from the working fluid to the fuel.

As shown in FIG. 2, working fluid exiting the GF-heat exchange subsystem 35 may be returned to the WF heating subsystem 20 through WF return conduit 435. The flow rate of the returning working fluid may be monitored with WF return flow meter 439. The returning working fluid may be conveyed to a mixing chamber 440. Instrumentation may be disposed downstream from the mixing chamber 440, such as WF-MC return flow meter 441, WF-MC return pressure transducer 442 and WF-MC return thermocouple 443 to provide flow rate, pressure and temperature information of the returning working fluid to the controller 45. The working fluid may be passed through a strainer 444 to filter any solid contaminants before returning to the WF heating subsystem 20.

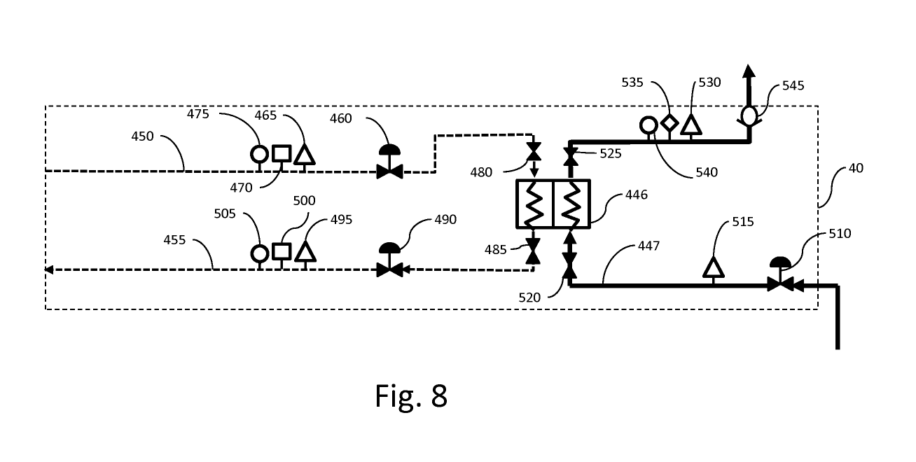

Illustrated in FIG. 2 and in more detail in FIG. 8 is the over temperature protection subsystem 40 that controls the temperature of the working fluid. The over temperature protection subsystem 40 includes a working fluid input conduit (WF input conduit 447) that conveys working fluid to a reverse flow configured heat exchanger (WF-heat exchanger 446). Coolant flows from coolant input conduit 450 through WF-heat exchanger 446 and into coolant exit conduit 455. Flow of the coolant into the WF-heat exchanger 446 is controlled by coolant upstream control valve 460. Information related to the coolant flowing into the WF-heat exchanger 446 such as flow rate, pressure and temperature may be provided by coolant upstream flow meter 465, coolant upstream pressure transducer 470 and coolant upstream thermocouple 475. Coolant upstream block valve 480 and coolant downstream block valve 485 may be provided to isolate possible leaks of coolant in the WF-heat exchanger 446 and may also be beneficial for maintenance of over temperature protection subsystem 40 including the ability to disconnect quickly the WF-heat exchanger 446 from the closed circuit 75 without major disassembly of system components and conduits. The over temperature protection subsystem 40 may also include a coolant downstream control valve 490. Coolant downstream control valve 490 provides flow control of coolant through the WF-heat exchanger 446. For example, closing down of coolant downstream control valve 490 provides longer dwell times of the coolant through the WF-heat exchanger 446 allowing for increased heat transfer from the working fluid to the coolant helping to reduce the working fluid temperature. Instrumentation such as coolant downstream flow meter 495, coolant downstream thermocouple 500, and coolant downstream pressure transducer 505 may also be provided downstream of the coolant downstream control valve 490. The over temperature protection subsystem 40 may be provided with a WF temperature control valve 510 as a control component to control the flow of working fluid through the WF-heat exchanger 446. A flow meter (WF-HX upstream flow meter 515) may be provided downstream of the WF temperature control valve 510 to provide working fluid flow rate information to the controller 45. WF-HX upstream block valve 520 and WF-HX downstream block valve 525 may be provided to isolate possible leaks of working fluid from the WF-heat exchanger 446 and may also be beneficial for maintenance of over temperature protection subsystem 40 including the ability to disconnect quickly the WF-heat exchanger 446 from the closed circuit 75 without major disassembly of system components and conduits. Instrumentation may be provided downstream of the WF-heat exchanger 446, such as WF-HX downstream flow meter 530, WF-HX downstream pressure transducer 535, and WF-HX downstream thermocouple 540. A WF-HX downstream one-way valve 545 may be provided to ensure a one way flow of the working fluid.

In operation, coolant flows from a coolant source (not shown) through coolant input conduit 450. The flow rate of the coolant is controlled using coolant upstream control valve 460 and coolant downstream control valve 490, which are in turn controlled by controller 45. Working fluid flows through the WF input conduit 447 and through the WF-heat exchanger 446. The flow rate of working fluid flowing through the heat exchanger is controlled through WF temperature control valve 510, which is in turn controlled by controller 45. Inputs to the controller 45 include coolant and working fluid flow rate, temperature and pressure information provided by coolant upstream thermocouple 475, coolant upstream flow meter 465, coolant upstream pressure transducer 470, coolant downstream flow meter 495, coolant downstream thermocouple 500, coolant downstream pressure transducer 505, WF-HX upstream flow meter 515, WF-HX downstream flow meter 530, WF-HX downstream pressure transducer 535 and WF-HX downstream thermocouple 540. Heat is transferred from the working fluid to the coolant by means of WF-heat exchanger 446, thereby controlling the temperature of the working fluid in the system.

As shown in FIG. 2, replacement working fluid may be provided through replacement working fluid conduit 550 and pumped into the closed circuit fuel heating system 10 with replacement working fluid pump 555. Replacement working fluid pump 555 may include replacement WF relief valve 560 that controls the pressure of the replacement working fluid and that recirculates working fluid exiting the replacement working fluid pump 555 by diverting a portion of the flow when necessary. The flow of replacement working fluid is controlled by replacement WF downstream control valve 565. Replacement WF downstream block valve 570 and replacement WF upstream block valve 575 may be provided to isolate possible leaks of working fluid from the replacement working fluid pump 555 and may also be beneficial for maintenance of the replacement working fluid pump 555 including the ability to disconnect quickly the replacement working fluid pump 555 from the circuit without major disassembly of system components and conduits. Instrumentation such as replacement WF upstream thermocouple 580, replacement WF downstream pressure transducer 585, replacement WF upstream pressure transducer 590 and replacement WF downstream thermocouple 595 may provide replacement working fluid pressure and temperature information to the controller 45. A replacement WF downstream one-way valve 600 may be provided to ensure the one way flow of the replacement working fluid. Mixing chamber upstream block valve 605 and mixing chamber downstream block valve 606 may be provided to allow for maintenance of the Mixing chamber 440. Mixing chamber input flow meter 610 may be disposed upstream from the mixing chamber 440. A mixing chamber bypass conduit 615 provided with a mixing chamber bypass block valve 620 may be provided for the purpose of bypassing the mixing chamber 440. The mixing chamber 440 may also be provided with a drain conduit 625 and a drain conduit control valve 630.

Controller 45 may be a gas turbine model-based control system designed to adjust the position of the various control valves to regulate the temperature to hit target modified Wobbe index (MWI) for the supply fuel based on fuel analyzer and fuel flow meter measurements. Controller 45 may be a general purpose computer, special purpose computer, or other programmable data processing apparatus.

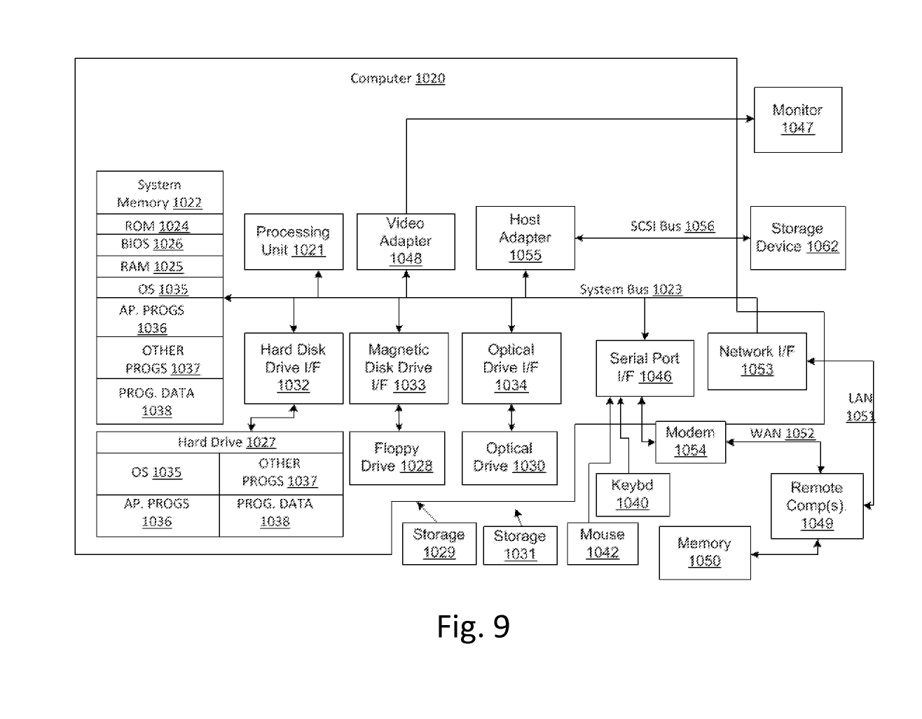

FIG. 9 is a block diagram of a computer 1020 in which the controller 45 may be incorporated. Computer 1020 includes a processing unit 1021, a system memory 1022, and a system bus 1023 that couples various system components including the system memory to the processing unit 1021. The system bus 1023 may be any of several types of bus structures including a memory bus or memory controller, a peripheral bus, and a local bus using any of a variety of bus architectures. The system memory includes read-only memory (ROM) 1024 and random access memory (RAM) 1025. A basic input/output system 1026 (BIOS), containing the basic routines that help to transfer information between elements within the computer 1020, such as during start-up, is stored in ROM 1024.

The computer 1020 may further include a hard disk drive 1027 for reading from and writing to a hard disk (not shown), a magnetic disk drive 1028 for reading from or writing to a removable magnetic disk 1029, and an optical disk drive 1030 for reading from or writing to a removable optical disk 1031 such as a CD-ROM or other optical media. The hard disk drive 1027, magnetic disk drive 1028, and optical disk drive 1030 are connected to the system bus 1023 by a hard disk drive interface 1032, a magnetic disk drive interface 1033, and an optical drive interface 1034, respectively. The drives and their associated computer-readable media provide non-volatile storage of computer readable instructions, data structures, program modules and other data for the computer 1020. As described herein, computer-readable media is an article of manufacture and thus not a transient signal.

Although the exemplary environment described herein employs a hard disk, a removable magnetic disk 1029, and a removable optical disk 1031, it should be appreciated that other types of computer readable media, which can store data that are accessible by a computer, may also be used in the exemplary operating environment. Such other types of media include, but are not limited to, a magnetic cassette, a flash memory card, a digital video or versatile disk, a Bernoulli cartridge, a random access memory (RAM), a read-only memory (ROM), and the like.

A number of program modules may be stored on the hard disk, removable magnetic disk 1029, removable optical disk 1031, ROM 1024 or RAM 1025, including an operating system 1035, one or more application programs 1036, other program modules 1037 and program data 1038. A user may enter commands and information into the computer 1020 through input devices such as a keyboard 1040 and pointing device 1042. Other input devices (not shown) may include a microphone, joystick, game pad, satellite disk, scanner, or the like. These and other input devices are often connected to the processing unit 1021 through a serial port interface 1046 that is coupled to the system bus 1023, but may be connected by other interfaces, such as a parallel port, game port, or universal serial bus (USB). A monitor 1047 or other type of display device is also connected to the system bus 1023 via an interface, such as a video adapter 1048. In addition to the monitor 1047, a computer may include other peripheral output devices (not shown), such as speakers and printers. The exemplary system of FIG. 9 also includes a host adapter 1055, a Small Computer System Interface (SCSI) bus 1056, and an external storage device 1062 connected to the SCSI bus 1056.

The computer 1020 may operate in a networked environment using logical connections to one or more remote computers, such as a remote computer 1049. The remote computer 1049 may be a personal computer, a server, a router, a network PC, a peer device or other common network node, and may include many or all of the elements described above relative to the computer 1020, although only a memory storage device 1050 has been illustrated in FIG. 9. The logical connections depicted in FIG. 9 include a local area network (LAN) 1051 and a wide area network (WAN) 1052. Such networking environments are commonplace in offices, enterprise-wide computer networks, intranets, and the Internet.

When used in a LAN networking environment, the computer 1020 is connected to the LAN 1051 through a network interface or adapter 1053. When used in a WAN networking environment, the computer 1020 may include a modem 1054 or other means for establishing communication over the wide area network 1052, such as the Internet. The modem 1054, which may be internal or external, is connected to the system bus 1023 via the serial port interface 1046. In a networked environment, program modules depicted relative to the computer 1020, or portions thereof, may be stored in the remote memory storage device. It will be appreciated that the network connections shown are exemplary and other means of establishing a communication link between the computers may be used.

Computer 1020 may include a variety of computer readable storage media. Computer readable storage media may be any available media that can be accessed by computer 1020 and includes both volatile and nonvolatile media, removable and non-removable media. By way of example, and not limitation, computer readable media may comprise computer storage media and communication media. Computer storage media include both volatile and nonvolatile, removable and non-removable media implemented in any method or technology for storage of information such as computer readable instructions, data structures, program modules or other data. Computer storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 1020. Combinations of any of the above should also be included within the scope of computer readable media that may be used to store source code for implementing the methods and systems described herein. Any combination of the features or elements disclosed herein may be used in one or more embodiments.

The terminology used herein is for the purpose of describing particular embodiments only and is not intended to be limiting of the invention. Where the definition of terms departs from the commonly used meaning of the term, applicant intends to utilize the definitions provided herein, unless specifically indicated. The singular forms “a”, “an” and “the” are intended to include the plural forms as well, unless the context clearly indicates otherwise. It will be understood that, although the terms first, second, etc. may be used to describe various elements, these elements should not be limited by these terms. These terms are only used to distinguish one element from another. The term “and/or” includes any, and all, combinations of one or more of the associated listed items. The phrases “coupled to” and “coupled with” contemplates direct or indirect coupling.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements.

What is claimed:

1. A system comprising:
a first fuel conduit providing a first fuel;
a closed circuit working fluid subsystem containing a working fluid, the closed circuit working fluid subsystem comprising;
a heat transfer subsystem disposed in a gas turbine exhaust; and
a first heat exchange subsystem coupled to the first fuel conduit and the heat transfer subsystem, the first heat exchange subsystem having a control component for controlling a flow of the working fluid through the first heat exchange subsystem.

2. The system of claim 1, further comprising a subsystem for controlling a temperature of the working fluid.

3. The system of claim 1, wherein the first heat exchange subsystem comprises a heat trace.

4. The system of claim 3, wherein the heat trace comprises a pair of conduits having a lune shaped cross-section surrounding the first fuel conduit.

5. The system of claim 1, further comprising:
a second fuel conduit providing a second fuel; and
a second heat exchange subsystem coupled to the second fuel conduit and the heat transfer subsystem, the second heat exchange subsystem having a control component for controlling a flow of the working fluid through the second heat exchange subsystem.

6. The system of claim 5, wherein the second heat exchange subsystem comprises a heat exchanger that transfers heat from the working fluid to the second fuel.

7. The system of claim 5, further comprising:
a third heat exchange subsystem having a control component for controlling the working fluid through the second heat exchange subsystem; and
a third fuel conduit coupled to the third heat exchange subsystem.

8. A method for heating one of a plurality of fuels used in a simple cycle gas turbine system, the method comprising:
selecting a first fuel to be combusted in the simple cycle gas turbine system from the plurality of fuels;
transferring heat from an exhaust to a working fluid flowing through a coil disposed in the exhaust;
conveying the working fluid to a heat exchange subsystem associated with the first fuel;
controlling a flow of the working fluid through the heat exchange subsystem;
flowing the first fuel through the heat exchange subsystem to heat the first fuel with the working fluid; and
returning the working fluid to the coil.

9. The method of claim 8, further comprising controlling a temperature of the working fluid.

10. The method of claim 8, wherein conveying the working fluid to a heat exchange subsystem comprises conveying the working fluid to a heat exchanger.

11. The method of claim 8, wherein conveying the working fluid to a heat exchange subsystem comprises conveying the working fluid to a heat trace.

12. The method of claim 8, wherein controlling a flow of the working fluid through the heat exchange subsystem comprises:
measuring a flow rate of the first fuel downstream of the heat transfer subsystem; and
controlling the the flow of the working fluid based on the flow rate.

13. The method of claim 8, further comprising controlling a flow of the first fuel through the heat transfer subsystem.

14. The method of claim 9, wherein controlling a temperature of the working fluid comprises:
flowing a coolant through a heat exchanger; and
flowing the working fluid through the heat exchanger.

15. A system comprising:
a compressor;
a combustor;
a turbine;
a working fluid heating subsystem that heats a working fluid;
a first fuel heating subsystem coupled to the working fluid heating subsystem;
a temperature control subsystem that controls a temperature of the working fluid;
a working fluid return subsystem that returns the working fluid to the working fluid heating subsystem; and
a controller that controls the working fluid heating subsystem, the first fuel heating subsystem, and the temperature control subsystem.

16. The system of claim 15, wherein the first fuel heating subsystem is a heavy fuel oil heating subsystem having a heat trace.

17. The system of claim 15, further comprising a second fuel heating subsystem coupled to the working fluid heating subsystem and wherein the second fuel heating subsystem is a liquid fuel heating subsystem having a heat exchanger.

18. The system of claim 15, further comprising a second fuel heating subsystem coupled to the working fluid heating subsystem and wherein the second fuel heating subsystem is a gas fuel heating subsystem having a heat exchanger.

19. The system of claim 15, wherein the temperature control subsystem comprises:
a heat exchanger; and
a source of coolant flowing through the heat exchanger.

20. The system of claim 16, wherein the heat trace comprises:
a pair of conduits having a lune shaped cross-section surrounding a first fuel conduit.
